(19) United States
(12) Patent Application Publication
(10) Pub. No.: US 2003/0208398 A1
(43) Pub. Date: Nov. 6, 2003

(54) Idea market

(76) Inventor: David Andrew Pearson, Hunt. Bch., CA (US)

Correspondence Address: DAVID PEARSON, 22102 CAPE MAY LN., HUNTINGTON BCH, CA, 92646-8415, US

(21) Appl. No.: 10/136,635

(22) Filed: May 2, 2002

(51) Int. Cl. G06F 17/60

(52) U.S. Cl. 705/14

(57) ABSTRACT

The advertisement of inventions as a means to protect, access value and attempt to market them. The inventions would be described and a percentage of ownership would be offered in the advertisments. The inventor would be identified and a copy of the advertisment can be retained by the inventor for protection. The percentages can be (very small) (so that they are) (affordable).

### FIELD

1. Advertising

The invention relates to the marketing of inventions

2. Prior Art

Currently, the method for marketing, protecting and accessing value of inventions described here-in is not present in the prior art.

### BRIEF SUMMARY

The object of this invention is to use advertising to protect and access value of inventions and the like. The inventions would be described to the public by advertising as a means for protection. The advertised descriptions would be an (inexpensive) way to protect and access value of the inventions. The advertisments would access value and (attempt to) market the inventions by offering a percentage of them for sale to the public. Copies (or other proof) of the advertisments can be retained by the inventors to use as proof that they are, in fact, the inventors of the inventions.

This invention is a marketing strategy aimed at eliminating the need for patents. It is expected that it might make them obsolete and take thier place.

It is anticipated that it can also function as a way to pay for the expenses of obtaining a patent for successful inventions: Small percentages of said inventions can be sold and the revenue can be used to pay for fees, lawyers (and other such expenses). Further, It is anticipated that it can be used to determine whether a patent on an invention is worth pursueing: If unable to sell percentages, it can be assumed that it is not worth it.

The concept can be used for types of ideas for which patents/trademarks are not normally pursued. The inventions mentioned here-in can be ideas for patents or trademarks. It is expected that the transactions described here-in can be done by mail. It is expected that contracts can be used. said contracts can be subject to change. It is a suggestion that they can stipulate that they are not valid unless proof of payment. for example, returned checks or reciepts from the inventors (behalf) are attached to (copies of) It is also suggested that the contracts. can be altered if unsatisfactory to the buyers. It is expected that all of the preceeding information can be explained by the advertisers.

### BRIEF DESCRIPTION OF THE DRAWING

FIG. 1 is a front view.

### DETAILED DESCRIPTION OF THE DRAWING

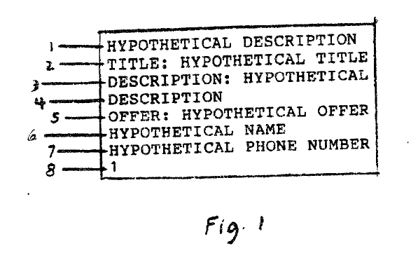

FIG. 1 illustrates an example of an advertisment. The advertisment is subject to change. It is expected that the advertisers can suggest that it can be altered if it is determined that it is unsatisfactory. The embodiment of this example is an ad in a newspaper classified section. (The ad can be in the miscellaneous subsection). The embodiment can be subject to change.

1. Advertisment description can be a description of the advertisment. An example is a description that specifies that (part of) an invention is for sale. The example can say: “Part of an invention for sale”. Format for the letters can be subject to change. For example, bold/(small case or) capitol letters can be used. The description can specify an idea [for trademark(s) or a web page(s)],a group of ideas, one or more subsets (subgroups) of (multiple) groups (and so on) of (related) ideas/inventions, an invention or a group of inventions. USPTO information can be included.

2. Title can be a (discriptive) name for the invention

3. Description can be a description of the idea. (Just) enough detail (or other information) can be used to adequately explain the idea to the readers so that they would understand it. USPTO information can be included.

4. Offer can be any information that might generate revenue (directly) from (the hypothetical results of) (aspects/parts of) an idea [for a trademark(s) for/or a web page(s)], (an invention), a group of ideas/inventions one or more subsets (subgroups) of (multiple) groups (and so on) of (related) ideas/inventions. An example is an offer to sell (legal) ownership of one or more percentages of the described invention. The offer can be for one or more shares at a predetermined percentage rate. Percentage rate can be subject to change. Percentage rate can very with quantity of percentage purchased. Percentage rate can be (described) in dollars per percent or percentage. Amount of (offered) can be subject to change (one hundred percent included). Examples include offers to sell one hundreth of one percent for fifty dollars and offers to sell fifty one percent for one million dollars. An example ofd the offer can say: “1% for $500”.

5. Identifier can be the name of the inventor. Full names and initials can be used. Other (types of) information can be used; (parts of) social security numbers, license numbers or addresses for instance. It can be used to identify the inventor.

6. Phone number can be a phone number. It can be the phone number of the inventor. It can be used to further identify the inventor.

7. Invention number can be a (legal) number assigned to the invention. It is expected that it can have the same effect as a patent number and that information about it can be disclosed by the advertisers. It is also expected that numbers assigned by the USPTO and/or trademark information can (also) be included.

All of the part numbers can be subtractable and the information in them can be subject to change.

The possibility of the replacement of the information in the described advertisments with aspects of (the same or other) information is expected. The possibility of explaining such (aspects of) information in (the described) section headings or elsewhere by the advertisers is expected. The possibility of leading to the information by the advertisers using aspects or codes to explain aspects or codes and so on and the placement of (aspects of or codes for) the information/explainations in (the equivalent of) other or the same sections and/or parts or elsewhere (by the advertisers) is expected.

It is also expected that the internet and newspaper classified sections and the like can be used to market ideas. It is also expected that internet addresses can be used to (further) identify the inventors.

It is expected that signs [for vehicles that advertise things (other than or along with said vehicles)] that are for sale can be used to market ideas. Said things can include items, services,etc. It is also expected that such signs can be in the format of a for sale sign without the words “for sale” on it. It is also expected that said signs can contain any erasable information. It is also expected that fliers and the like (containing personal ads) can be produced and distributed (by mail) (to/for the inventors) to market ideas.

The possibility of (dedicated) publications for marketing ideas and the use of air waves, satillite/cable (television/radio) as a means to market ideas is also expected. It is also expected that [(amature) stations that use] citizens band radio and the like can be used to market ideas. Such stations can contain a (short wave) radio and an operater/announcer who reads/broadcasts personal ads using said radio. It is expected that such radio stations could also broadcast in the format of conventional radio stations and that radios/scanner(s) (modifications) can be produced and distributed to recieve at such frequencies. It is also expected that bandwidths can be assigned for such stations and that (two way) radios can be produced and distrbuted for them. It is expected that such radio operators could advertise (in newspaper classified sections and the like, phone books,etc., or from thier own radios) to generate bussiness for (citizen's band/short wave/ham/side band) (personal) radio advertisments.

The possibility of using bus (stop bench) signs, as a means to market ideas and the marketing of ideas at stores banks and the like is expected. The possibility of vending machines and magazines to market ideas is also expected.

The possibility of the use of advertising (in newspaper classified sections, phone books, etc.) to generate bussiness for the use of telemarketing ([and (other) phone line media] to market ideas is expected. It is expected that bussiness for (the described concept of) marketing ideas can be solicited (generated) by advertising (in phone books). It is also expected that (dedicated) (sub)sections can be used in newspaper classified sections and the like, by internet advertisers and by the other advertisers [(any other embodiments) that advertise in the format of the described idea marketing concept] for the described advertisements. It is also expected that said sections can include headings that describe the explained idea marketing concept It is also expected that such headings can disclose information about (the intention of) protection for the ideas advertised. It is also expected that they can disclose information about the (expected) probability that the ideas advertised are (either) new or unsuccessful if the readers are unfamiliar with them and that they can also disclose that research is less or not needed because of that. It is also expected that (all of) the advertisers can disclose such information (all of the information listed for said headings included).

It is expected that the described advertisments can include information pertaining to research for the ideas that are advertised in them. It is expected that the ideas can be researched (by the inventors of them, by the advertisers or by third party(s) (research contractors). It is also expected that the advertisements can contain (certified) information about such research. It is also expected that the scope of such is subject to change and that said scope can be (certified and) documented by the advertisments. It is also expected that the research information can be coded and that the coded information can be explained in the described section headings.

(Perferated) pages from (the advertisers) the embodiments that are in the form of newspaper classified sections and the like and pages from internet adverisers that contain one or more of the described advertisments can contain identification information and a date. It is expected that(the described section headings can suggest that)the inventors can retain said pages to protect thier advertised ideas.

It is also expected that (copies of) a (certified) (legal) document(s); [a contract(s) that is adequate. for (all of) the proposed transactions can be supplied [for an (extra) fee] (by those who vend and any other embodiments that got involved with) (the described concept for) (the marketing of ideas). It is also expected that said contract(s) can stipulate that the described percentages are transferable and whether they are subject to change for advertised ideas that become patented. It is expected that in such scenarios the percentage owners of ideas would become the percentage owners of patents on said ideas. It is expected that The contracts can include information about whether said owners recieve rights to any new material and/or (new) ideas/inventions that result from the application of said patents.

Further, it is expected that (copies of) another document(s); [instructions for making the transactions (legal)] that is adequate for (all of) the proposed transactions, can also be distributed (in such a manner). It is also expected that (such distrbution means can be used for) other (such) documentation (for) (the described concept of) (idea) (marketing). The possibility of the use of said documentation is also expected.

Further, it is also expected that the way that the transactions are done; (for example, in person, by mail or with the internet) (and) (or) the type of transactions is/are subject to change. It is also expected that the scope of advertising; [for example, locally, nationally, world wide or an imbetween of some sort (state wide)] (for) (all of) (the) advertisers is subject to change.

The possibility of phone numbers that charge an extra fee by the minute for (responding to or placing the adverisments of) (the described concept of) idea marketing is expected.

It is expected that the previously described section headings can disclose information to the effect small percentages of ideas can be sold and the revenues can be used to (attempt to) obtain (legal) protection (patent numbers and the like) for them. It is also expected that said headings can include information about any (legal) numbers that are assigned to the ideas advertised (by third parties and/or the advertisers). Further, it is expected that information about patent numbers and the like can be (coded) (and) (explained) in said headings.

It is expected that said headings can disclose (information about) the described contracts and/or instructions. It is also expected that said headings can include information to the effect that if a contract appears legal it is legal accompanied by suggestions for the inventors to write thier own contracts. It is expected that said headings can include information to the effect that a/the format for the described transactions (can) (be offered) (to) make(s) them legal (for an extra fee). It is expected that said headings can include disclaimers to relinquish responsibility for information or suggestions in them.

It is expected that information (from the USPTO) (patent numbers and the like) in the described advertisments can be coded (or abbreviated) and that said coded information can be explained in said headings. Further, it is expected that said headings can be subject to change.

It is expected that prices for the described advertisments can differ for advertisments that contain different or additional information (presence or absence of patent numbers and the like for instance). It is expected that the cost of the described advertisments can be lowered if it seems to be too high (insufficent amount of customers) or raised if it seems to be too low (if more revenue can be generated by raising it). It is expected that said cost can be left stationary or adjusted in the right or wrong direction (towards optimization) whether (regardless of how) it seems to be and/or is; (too high, optimized, or too low. It is expected that said cost can be subject to change. Further, it is expected that price adjustments for the described advertisments can be advertised (to attempt to) (generate more bussiness) (or more revenue).

It is expected that the described section headings can explain that the described advertisments can be for offers to purchase percentages of ideas and/or the resulting patents after the ideas are patented for ideas that are not (yet) patented. It is expected that the section headings can disclose information about the availability of (copies of) contracts to legally enforce such agreements.

At is expected that the types of offers described in the in the advertisments can be subject to change. The possibility of (explained) subsections for different types of offers, different types of ideas, ideas with USPTO numbers assigned,trademarks and other (such) variables is expected.

It is expected that the advertisments and/or the section headings can explain that the offers to/from the customers/inventors can relate to (such) variables as (questionable) agreements to purchase percentages of ideas if the inventors recieve numbers (and/or trademark registration) from the USPTO for said ideas. It is expected that the advertisers can explain that (the) (such) offers can be subject to change.

Apparatueses disclosed here-in that can (be used to) market ideas can put forth (other) (personal) advertiments.

It is expected that the advertisers can explain that the described contracts can stipulate whether the percentage buyer recieves legal rights to predicted predicted concepts contained in patents or patent applications.

It is expected that the (hypothetical) results of ideas, new products, for instance, can be advertised in such a manner as described. The use of such advertisments to offer to take orders for things that have been invented; the (hypothetical) results of ideas with or without USPTO numbers or trademark registration that are not (yet) prepared or manufactured is expected. Such results can be in the form of but not limited to, the general field of subject matter that can be patented as specified by the patent law.

This type of advertisment can target individuals (by offering small quantities or one at a time) or it can target distributors/(retail) sellers (by offering to take large scale orders).

It is expected that this type of advertisment can go into the described subsections or (dedicated) (sub) subsections for it. It is expected that the described section headings can explain the concept and that these advertisments are attempts at marketing ideas and optionaly that the success of the advertisments can determine whether the products/results would be manufactured/prepared for distribution.

It is expected that the section headings can disclose information about the availability of (copies of) contracts that can be supplied by the advertisers or third It is also expected that the section headings can explain that the contracts can legalize agreements/transactions for (non-refundable) orders that are paid for in advance.

It is expected that the described concept for protecting/marketing ideas can be used to (attempt to) market/protect aspects/parts of ideas/inventions and/or the results of (aspects/parts of)ideas/inventions.

Parameters for the described concept of (attempting to) market ideas can be subject to change.

It is expected that information about additional ideas/inventions can be included and that multiple ideas be advertised in the described advertisments.

The possibility of removable apparatuses for replacable (personal) advertisments for buses and the like is expected. It is expected that such apparatuses and removable advertising apparatuses for [predicted (motorized) (vehicular)] shopping carts can be used to market ideas.

It is expected that advertising can be used to generate bussiness for the distribution of the predicted fliers and the like (from third parties) (by mail) (to/for the inventors) to market ideas. It is expected that the fliers can be passed out and/or distributed in ways that fliers are normally distributed.

The possibility of the production of items of value that are not normally used for advertising with personal ads on them is expected. Further, it is expected that such items can be distributed like the fliers to market ideas. It is expected that the ads can be small enough so that a magnifying glass is needed to read them or that they can be on microfilm.

The possible expectation of computer disks and the like containing (a program that reads) personal ads and recordings of personal ads is examined. It is expected that such things can be distributed like the fliers. Further it is expected they can be included with the items of value.

All material put forth here-in using the word “expected” and the like are intended as (possible) predictions.

It is a plan to change “DETAILED DESCRIPTIONS OF THE DRAWINGS” to “DETAILED DESCRIPTIONS” if accepted.

1. The use of advertising as a means to (attempt to) generate revenue directly from ideas/inventions.

2. The use of advertising as a means to (attempt to) protect ideas/inventions.
